(19) United States
(12) Patent Application Publication
(10) Pub. No.: US 2005/0031171 A1
(43) Pub. Date: Feb. 10, 2005

(54) Apparatus for objects detection and image/color identification

(76) Inventors: William Krukowski, Naharia (IL); Michael Fridhendler, Naharia (IL); Meir Ayganim, Moshav Gealya (IL)

Correspondence Address: KATTEN MUCHIN ZAVIS ROSENMAN, 575 MADISON AVENUE, NEW YORK, NY, 10022-2585, US

(21) Appl. No.: 10/910,034

(22) Filed: Aug. 3, 2004

(30) Foreign Application Priority Data
Aug. 4, 2003 (IL) 157235

(51) Int. Cl. G06K 9/00

(52) U.S. Cl. 382/114

(57) ABSTRACT

An apparatus for identifying images includes a body, a digital camera located within the body, a memory for storing previously recorded data relating to each of an array of images, a light source within the body, and electronic unit for comparing data of a captured image with data of the array of recorded images, a voice module for outputting a message indicating a match of the data of the captured image to the data of a recorded image, and an input device for operating the device.

### CROSS-REFERENCE TO RELATED APPLICATION

The present application claims priority under 35 U.S.C. § 119 from Israel Application 157235, filed on Aug. 4, 2003.

### FIELD OF THE INVENTION

The present invention relates to the field of assistant devices for the blind and visually impaired community, including the colorblind. More particularly, the invention relates to an apparatus for detecting the presence of an object as well as the distance from the object, and also for identifying a color or an image, such as barcodes, banknotes, signs, symbols, letters etc., and producing an audible message which expresses the detection or identification.

### BACKGROUND OF THE INVENTION

While three dimensional objects can often be easily identified by the visually impaired by touch, images and colors cannot be similarly identified, nor can identically shaped objects be distinguished from each other by touch. An acute problem occurs when the visually impaired attempt to distinguish banknotes of varying denominations, which often differ only by surface images, color and text. Colorblind people are people with a normal degree of vision but have an inability to distinguish between two or more colors. They may also have difficulty perceiving details of banknotes. Of course, various pathological conditions may also impair the vision of persons who are neither blind nor colorblind.

Hereinafter, and unless otherwise stated, the term “visually impaired” refers to persons whose vision is impaired in any way and for any reason, particularly, but not exclusively, blind, colorblind, or other people who are unable to see or distinguish between banknotes.

The visually impaired also have a need to identify objects by color, for example, matching garments, locating color-coded labels, distinguishing ripe from unripe fruit, etc.

The visually impaired further have a need to quickly identify the source and/or the subject, and therefore the importance, of mail they receive. For example they need to know whether a letter they receive is from their lawyer or whether it is a circular letter from a supermarket.

Several devices to identify banknotes have been designed for large-scale sorting of banknotes by machine, processing cash in vending machines or providing security against counterfeiting. In general, such devices are intended for use by banks, vendors, and digital copying-and-printing systems. Few such devices are designed for small-scale identification or miniaturization, and fewer still for hand-held self-contained devices which can provide the visually impaired with an audible output. However, such devices that do provide audible output, lack the ability to identify images other than those of banknotes, or the ability to provide any color analysis. Furthermore, the structure of such devices is relatively complicated and therefore rather expensive for individual use.

U.S. Pat. No. 3,906,449 discloses a currency identifier that permits recognition of various denominations of paper currency by blind persons. The currency identifier includes a housing containing a tray upon which money to be identified is passed. In one embodiment, a source of light is stationed above the tray. Positioned directly under the light source is a series of very small holes formed in the bottom of the tray. The holes are aligned across the tray so that light from the source shines through the center of paper currency passed along the tray, through the holes, and onto a photoelectric cell located beneath the tray. The photocell is connected to a relaxation oscillator circuit and controls the oscillator frequency in accordance with the amount of light passing through the money. The output from the oscillator is connected to a loudspeaker which produces a tone that varies in accordance with the output from the photocell. Since the various currency denominations have distinct printed patterns and thus have different light responsive characteristics, the sounds produced can be identified as being representative of a specific bill. The light is transmitted onto the bill and a portion of the light is reflected onto the photocell. The reflected light is also characteristic of a particular bill and produces an identifiable tone pattern.

However, U.S. Pat. No. 3,906,449 uses only a single character to identify a banknote, and it does not use any additional references, such as the color of the banknote, in order to verify that the identification is correct. Furthermore, this invention uses only tones to characterize the identified banknote. This may cause confusion while the visually impaired person tries to figure out what banknote the tone relates to. This drawback increases in cases where this invention generates similar tones for different banknotes. Moreover, identifying the banknote requires moving the banknote along the currency identifier, which involves the use of a mechanical mechanism, thus complicating this invention.

U.S. Pat. No. 5,852,803 discloses an apparatus, system, and method for recording and retrieving voice information into a label attachable to a product. However, it does not disclose a method and system for using the same apparatus to identify colors and banknotes or other images, or to identify a string of alphanumeric signs (e.g., words, sentences etc.), or to detect or audibly announce the presence and distance of objects. Thus, if the visually impaired are to be able to distinguish identical three-dimensional objects (such as CDs), identify colors, banknotes, other images, and the source and subject of letters, and detect the presence and distance of obstacles so that they can find a clear path to walk along, they need to use (and often carry) several different instruments—one for each purpose.

U.S. Pat. No. 6,535,287 discloses a device for identifying a color, wherein a measurement aperture portion is pressed against the surface of an object the color of which a sight-impaired person desires to know, light (of three RGB types) reflected from the object is measured, a program calculates the measured data and compares the calculated data with reference data (table data) which is systematically classified, the color name of the measured data is selected, and the color name (the basic color name, lightness, chroma, and hue) of the object is output from a speaker. However, it is a drawback of devices such as this, that if they are pressed against the surface of an object with more than one color, they will average out the frequencies of the colors present and incorrectly announce one color that matches the average frequency, rather than the colors that are actually present; for example, if there is a pattern of narrow red and green stripes, they will announce the color of the object as yellow, since yellow is the composite of red and green in RGB.

It is an object of the present invention to provide an apparatus for identifying images on banknotes that overcomes the drawbacks of the prior art.

It is another object of the present invention to provide an apparatus that in addition to identifying images on banknotes will also identify images on other objects with at least one essentially flat surface, in particular barcodes and alphanumeric strings, but not limited to them.

It is another object of the present invention to provide an accurate color analysis of banknotes or other essentially flat objects.

It is still another object of the present invention to provide an apparatus for identifying an image on a banknote or another essentially flat object even when it has been inexactly positioned for the purpose of identification.

It is a further object of the present invention to provide an apparatus for identifying an image which is washed out or faded.

It is another object of the present invention to provide an apparatus that will detect and audibly announce the presence and distance of obstacles and other objects.

It is yet another object of the present invention to provide an apparatus which will discriminate and announce each different color present in the same image or object, and the percentage of each color in the image or object.

It is a still further object of the present invention to overcome the need for the visually impaired to use (and carry) a multitude of different instruments with different functions, by providing one instrument that can read barcodes, identify colors, identify banknotes and other images, read written sentences, and detect and announce the presence and distance of obstacles.

Other objects and advantages of the invention will become apparent as the description proceeds.

### SUMMARY OF THE INVENTION

The present invention is an apparatus for identifying images, which comprises:
(a) a body with an optional wing, said wing being displaceably, preferably pivotally, joined to said body for closing said body, wherein an object bearing an image to be identified may be placed between said body and said wing;
(b) a digital camera located within said body for capturing the image borne by an object placed between said body and said wing but optionally displaceable to capture images of objects placed outside the apparatus;
(c) a memory for storing previously recorded data related to each one of an array of images, said data comprising an array of images and an array of messages, preferably audio messages, corresponding to said array of images;
(d) a light source with adjustable brightness installed within said body for illuminating the image to be captured by said digital camera;
(e) an electronic unit for comparing the data of said captured image with the data of the previously recorded array of images, the data of said captured image being obtained by utilizing optical character recognition algorithm(s) and/or pattern recognition algorithm(s);
(f) a voice module for outputting the message corresponding to said captured image whenever said captured image matches an image of said previously recorded array of images; and
(g) an input device for operating said apparatus.

Preferably, the body further comprises a sensor for sensing the existence of an image in the body.

According to a preferred embodiment of the present invention, the apparatus further comprises a mirror installed within the body for reflecting the image to be captured by the digital camera.

Preferably, the apparatus of the present invention is so shaped that it can receive in a predetermined position the objects bearing images to be identified. Thus, in the typical case that the objects are banknotes, a flat space is defined between the body and the wing of the apparatus and the contour of said space is such that a banknote placed therein is held in a predetermined position.

According to a preferred embodiment of the present invention, the electronic unit comprises a central processing unit and memory.

According to one preferred embodiment of the present invention, the central processing unit uses a vector algorithm for identifying images which have been inexactly positioned within the apparatus.

According to a preferred embodiment of the present invention, the voice module comprises a voice processor, an audio amplifier, and a loudspeaker.

Preferably, the messages are audio messages, and more preferably vocal messages.

According to another preferred embodiment of the present invention, the apparatus for identifying images further comprises a tactile display for generating a message that can be read by touch.

According to another preferred embodiment of the present invention, the apparatus for identifying images further comprises a visual display for generating a message that can be read by sight.

According to a preferred embodiment of the present invention, the apparatus for identifying images further comprises means for identifying the color or colors of images and the percentage of each color present in them. Preferably, the means for identifying the color or colors of images, and their percentages, is the digital camera and the electronic unit.

According to another preferred embodiment of the present invention, the apparatus for identifying images further comprises means for identifying sentences of text and outputting them as speech. Preferably, the means for identifying sentences of text and outputting them as speech is the digital camera, the optical character recognition software, the electronic unit, and the voice module.

According to another preferred embodiment of the present invention, the apparatus for identifying images further comprises means for identifying barcodes. Preferably, the means for identifying barcodes is the digital camera and the electronic unit.

According to another preferred embodiment of the present invention, the apparatus further comprises a mechanism which enables the digital camera to swivel for focusing out of the body, thereby identifying images and/or the color of said images outside the body.

By another preferred embodiment, an apparatus is provided according to the present invention, which further includes messages stored in the memory, wherein each of said messages corresponds to a specific color. Preferably, the corresponding message is produced audibly by the voice module.

By another preferred embodiment, an apparatus is provided according to the present invention, which further includes messages stored in the memory, wherein each of said messages corresponds to a barcode. Preferably, the corresponding message is produced audibly by the voice module.

By another preferred embodiment of the present invention, an apparatus is provided for inputting a new image into the array of images stored in the memory. Preferably the means for inputting a new image into the array of images stored in the memory is the digital camera and the electronic unit.

By another preferred embodiment of the present invention, the means for inputting a new image further comprises means for inputting a new color into the array of colors stored in the said memory. Preferably the means for inputting a new color into the said array of colors stored in the said memory is the digital camera and the electronic unit.

By another preferred embodiment of the present invention, the means for inputting a new image into the array of images stored in the memory further comprises means for inputting a new barcode. Preferably the means for inputting a new barcode into the array of images stored in the memory is the digital camera and the electronic unit.

By another preferred embodiment of the present invention, an apparatus is provided for inputting a new message into the array of messages stored in the memory. Preferably the means for inputting a new message into the array of messages stored in the memory is a microphone and the electronic unit.

According to another preferred embodiment of the present invention, an apparatus is provided for the detection of the presence of an obstacle or object and the calculation of its distance. Preferably the means for the detection of the presence of an obstacle or object and the calculation of its distance is the camera, the electronic unit, and a distance measuring module, executed by a means well known to those skilled in the art (for example, according to U.S. Pat. No. 4,533,227). Preferably, the presence and distance of an obstacle or other object is announced audibly by the voice module.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1A schematically illustrates an apparatus for identifying an image and/or colors in an open position, according to a preferred embodiment of the present invention;

FIG. 1B schematically illustrates the apparatus for identifying an image and/or colors of FIG. 1A in a closed position;

FIG. 1C schematically illustrates the apparatus for identifying an image and/or colors of FIG. 1A provided with a banknote;

FIG. 2 is a cross sectional view of the apparatus of FIG. 1A in a closed position;

FIG. 3 is a cross sectional view of the apparatus of FIG. 1 in color identifier mode, according to the preferred embodiment of the present invention;

FIG. 4 schematically illustrates the electronic unit of the apparatus of FIG. 2;

FIG. 5 is a flowchart showing the general operation of the apparatus of the present invention irrespective of the function chosen, according to a preferred embodiment of the present invention;

FIG. 6 is a flowchart showing the operation of the apparatus while it is functioning as an obstacle detection and distance measuring device, according to a preferred embodiment of the present invention;

FIG. 7 is a flowchart showing the operation of the apparatus while it is functioning as a conversion of text sentences to speech device, according to a preferred embodiment of the present invention; and

FIG. 8 is a flowchart showing the operation of the apparatus while it is functioning as a color identification and image identification device, according to a preferred embodiment of the present invention.

### DETAILED DESCRIPTION OF PREFERRED EMBODIMENTS

Since the characterizing prints on banknotes and on other objects with at least one essentially flat object are generally images, they will be referred to hereinafter as “images”, but no limitation is intended by said term.

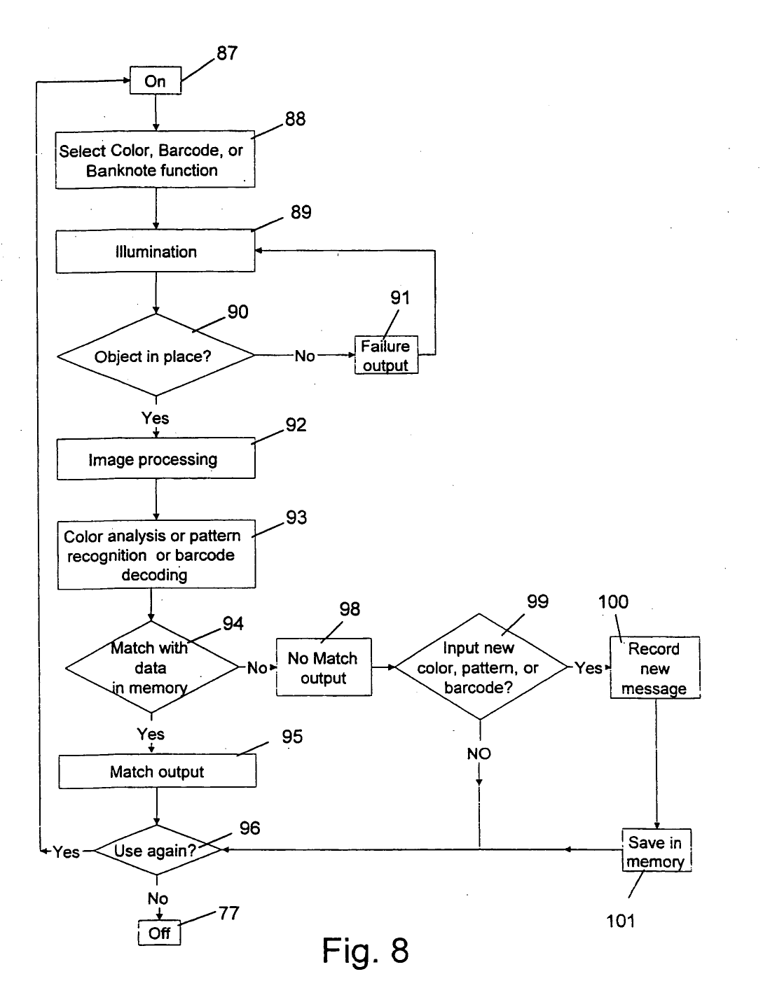

The present invention is an apparatus for identifying an image, according to an array of images that are stored in a memory. One or more identification details regarding the identified image may be provided by an audio message and/or by a tactile display (i.e., by a display that could be read by touch, e.g., Braille or similar system) and/or optionally by a visual display. In addition, the apparatus of the present invention also provides color analysis of the image, and detection of the presence and distance of obstacles and other objects, preferably within a fixed region. The color analysis allows the identification of each separate color in the images or objects and the percentage of each separate color in the images or objects, as will be described hereinafter with reference to FIG. 8

According to a preferred embodiment of the present invention, the apparatus, preferably, but not limitatively, uses image processing for comparing a captured image with images that are stored in a memory. Preferably, but not limitatively, each of the images stored in the memory represents the entire image, while the captured image may contain the entire or only a partial image of the banknote or other object to be identified. Thus, in the case that a banknote or another object to be identified has been inexactly positioned within the apparatus of the present invention, and therefore only a part of its image can be captured, it is possible to use the partial image for comparison; for example, when the size of a banknote is larger than the dimension of the apparatus and, thus, only part of the banknote can be captured.

It is assumed that the images to be stored in the memory can be obtained in several ways, which are well known to a person skilled in the art. For example, each image to be stored in the memory, preferably, for later identification of similar banknotes or objects, can be captured previously with a digital camera or a scanner, and then the data representing these captured images is stored in the memory. The apparatus of the present invention can also be used, if desired, as a device for capturing new images to be stored in memory. In cases where the image to be identified is placed within the apparatus of the present invention, at an angle that differs from the angle at which its corresponding stored image was captured, then, preferably, but not limitatively, a vector algorithm is used for overcoming such different placing of the images.

According to a preferred embodiment of the present invention, the apparatus for identifying images comprises a body with an open side and a wing that is displaceably, preferably pivotally, joined to the body and which can be displaced, preferably swung, to move and cover the opened side of the body. Inside the body, preferably—but not limitatively, there is a digital camera, a light source, a mirror, a distance measuring module, an electronic unit (that includes a central processing unit and a memory), and a voice module (that includes a voice processor, an audio amplifier, a loudspeaker and a microphone). The mirror and the light source are optional. The light source can be provided with brightness control.

When a user wishes to identify a flat object bearing an image, firstly the object is placed on the wing of the apparatus. Then the wing is closed against the body with the object between the body and the wing. Since a banknote is a typical flat object, reference will be made hereinafter to banknotes, to simplify the description, but no limitation is intended by this. A sensor, which is located within the body, senses that an image is placed inside the body, on the wing, and in turn it operates an electronic unit.

The electronic unit operates as follow:

A light source, located within the body, illuminates the banknote. As a result of the illumination, the image on the banknote is reflected off the mirror to the digital camera, which captures the image of the banknote. The central processing unit compares the captured image with each of the images that are stored in the memory, in order to locate a matching image. The data of the captured image is obtained by utilizing optical character recognition algorithm(s) and/or pattern recognition algorithm(s). For example, the central processing unit uses a vector algorithm which can compare images even when they were captured from different angles. For each image stored in the memory, a corresponding message is also stored in the said memory and the message contains, for example, the image details or other information. Preferably, but not limitatively, the message is a vocal message which tells the user which banknote has been placed within the apparatus. Whenever the captured image matches an image stored in the memory, the corresponding message is output. The message can be replayed by the voice module, displayed on the visual display unit, and displayed on the tactile display.

The principles and operation of the apparatus according to the present invention may be better understood with reference to the drawings and the accompanying description.

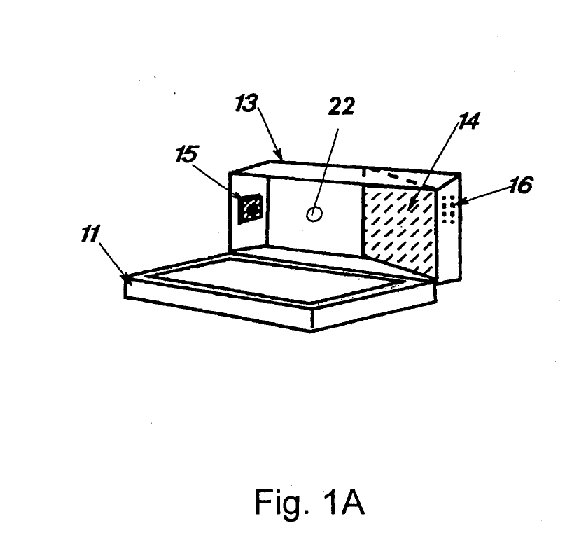

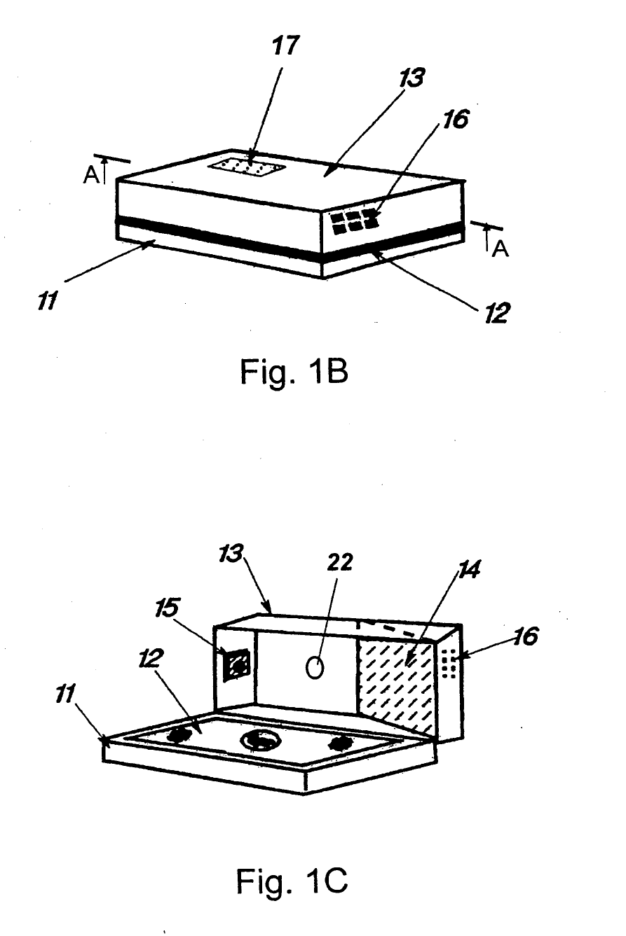

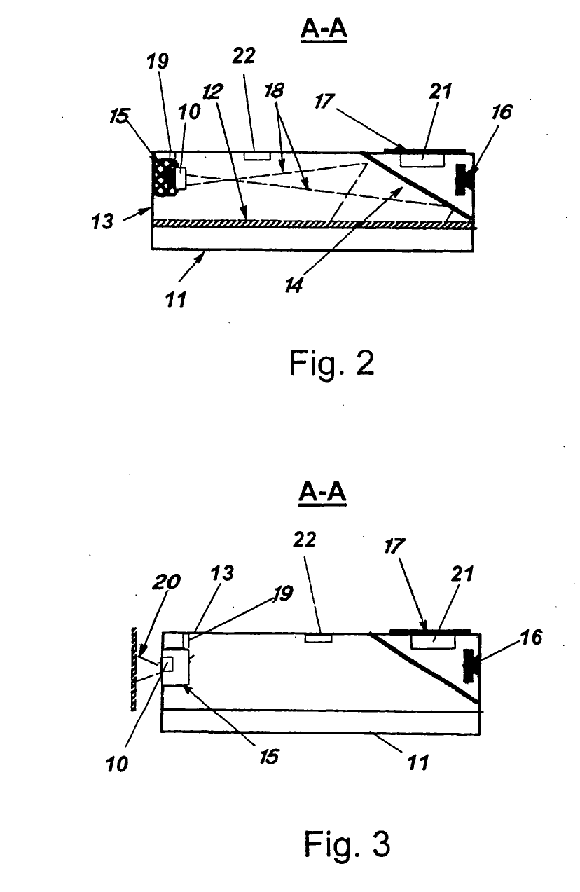

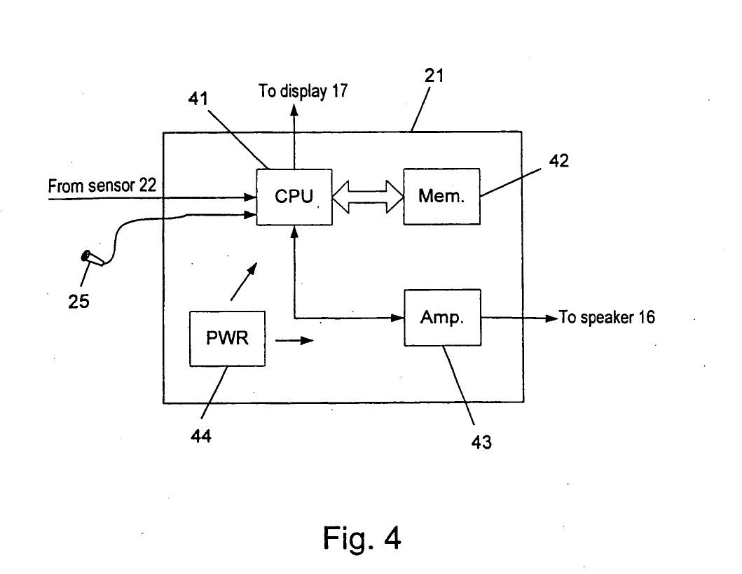

Reference is first made to FIGS. 1A and 1B, which schematically illustrate an apparatus for identifying an image and/or color in an open position and in a closed position respectively, according to a preferred embodiment of the present invention. The apparatus, according to the embodiment illustrated in FIG. 1A, comprises a wing 11 that is pivotally joined to a body 13. The body 13 includes a mirror 14; a digital camera 15; a sensor 22; an electronic unit 21 (FIGS. 2 and 3), which includes a central processing unit 41 (FIG. 4) and a memory 42 (FIG. 4); and a voice module 43 (FIG. 4), which includes a voice processor 23, an audio amplifier 24, a loudspeaker 16, and a microphone 25.

FIG. 1C schematically illustrates the apparatus for identifying an image and/or colors of FIG. 1A with the addition of a banknote 12. In this figure, an image, such as the one of banknote 12, is placed on wing 11.

When the apparatus of the present invention is closed, the electronic system is activated as soon as the sensor senses that banknote 12 is located between the wing 11 and the body 13. Whenever the image of banknote 12 matches an image of an identical banknote that was previously stored in the memory, the electronic system will sound the corresponding message via speaker 16.

According to a preferred embodiment of the present invention, the apparatus for identifying images further comprises a mechanism for enabling the digital camera to turn over for focusing out of the body, thereby identifying images and/or the color of said images outside the body.

According to a preferred embodiment of the present invention, the electronic unit further comprises a communication port for linking the apparatus of the present invention to other devices, such as PC, palm, laptop etc. The communication can be established by using any suitable communication protocol, such as USB, RS-232, IR and the like.

FIG. 2 is a cross-sectional view of the apparatus of FIG. 1A. The banknote 12 is placed between the wing 13 and the body 11. Illumination 18 from the light source 10 reflects off the mirror onto the banknote 12. The image of the banknote 12, or at least part of the image of the banknote, is reflected onto the mirror; and the digital camera 15 captures the reflected image of the banknote. The central processing unit 41 (FIG. 4) uses a pattern recognition algorithm to check if there is an image in the memory 42 (FIG. 4) that matches the captured image. If the central processing unit 41 finds a matching image, the central processing unit 41 operates the voice module 43 (FIG. 4) to announce the corresponding message or displays a message on the display 17. If the central processing unit 41 does not find a matching image, it may cause a message to be output that announces there is no matching image. The processing unit 41 (FIG. 4) can then input the captured image into the memory 42 (FIG. 4). Preferably, the light source 10 that illuminates banknote 12 is provided by the digital camera 15. According to another preferred embodiment of the present invention, the light source 10 is provided by another light source located within the body. Of course, the digital camera 15 could be an infra-red based camera, so that the provided light source is an infra-red beam.

When a new image is input into the memory 42 (FIG. 4), a description of the new image can be recorded by the microphone 25 (FIG. 4) and input into the memory 42 (FIG. 4) by the central processing unit 41 (FIG. 4), such that the new message corresponds to the new image.

FIG. 3 is a cross-section of the apparatus in color identification mode. The digital camera 15 can be rotated on an axis 19 to focus outside the body 11. The digital camera 15 captures the color of the image 20 and in the same manner as in the case of identifying an image, a message is announced via the speaker 16 and/or displayed on the display 17. The display 17 can be a tactile display, which displays in a way that can be read by touch e.g., Braille. The display can also be a visual display.

According to a preferred embodiment of the present invention, an image which is washed out or faded can also be identified by the apparatus of the present invention. This is done by utilizing suitable image processing means, which are well known to a skilled person in the art, such as using an edge detector algorithm or other image processing algorithms suitable to aid in identifying the image.

In order to operate the apparatus of the present invention, any suitable form of the electronic unit 21, can be provided. For example, FIG. 4 schematically illustrates a preferred configuration of the electronic unit 21. According to this configuration, the electronic unit 21 comprises a central processing unit 41 a memory 42, a microphone 25 and an audio amplifier 43 for ampliing the output to the loudspeaker or speaker 16. The power source 44 is a suitable storage cell for electricity, such as a battery etc. According to a preferred embodiment of the present invention, the electronic unit 21 further comprises means for identifying images that are barcodes. Preferably, the identification of such barcodes is obtained by using a suitable barcode algorithm(s) which are stored within a memory related to the electronic unit 21, such as memory 42 or other external memory unit (not shown).

According to a preferred embodiment of the present invention, the electronic unit 21 further comprises means for identifying images that are a printed string of alphanumeric signs (e.g., sentences, words, numbers etc.) and announce them audibly by outputting them as speech. Preferably, the means for identifying printed sentence images and outputting them audibly as speech are Optical Character Recognition (OCR) algorithms processed by the central processing unit 41, and the elements of the voice module as described hereinabove. The OCR algorithms are stored within a memory related to electronic unit 21, such as memory 42 or other external memory unit (not shown).

According to the preferred embodiment of the present invention, the apparatus further comprises means for inputting new images into the array of images stored in the memory 42. Preferably, the means for inputting new images are the digital camera 15 (FIG. 2) and the electronic unit 21 (FIG. 2).

According to the preferred embodiment of the present invention, the apparatus further comprises means for inputting new messages into the array of messages stored in the memory 42 (FIG. 4). The new messages correspond to images that have been put into the array of images stored in the memory 42. Preferably, the means for inputting new messages are the microphone 25 (FIG. 4) and the electronic unit 21 (FIG. 4).

According to the preferred embodiment of the present invention, the apparatus further comprises means for magnifying images and objects, and means for outputting the magnified object and/or image. Preferably, the means for magnifying images and objects are the camera 15 (FIG. 2), the electronic unit 21 (FIG. 3) and a magnification algorithm stored within a memory related to the electronic unit 21, such as memory 42. Preferably, the means for outputting the magnification is a visual display, such as display 17. Of course, the data representing the magnification can be output via the communication port to other devices.

According to the preferred embodiment of the present invention, the apparatus further comprises means for detecting the presence of objects, means for calculating their distance and means for outputting data representing the presence and the distance of the objects. Preferably, the means for detecting the presence of objects and calculating their distance are the camera 15, the electronic unit 21, and the distance measuring module connected to the electronic unit 21 (not shown). Preferably, the means for outputting the data representing the detection and the distance of objects is the voice module and/or the display 17 (i.e., either tactile or visual display). Of course, the data representing the detection and the distance of objects can be output via the communication port (not shown).

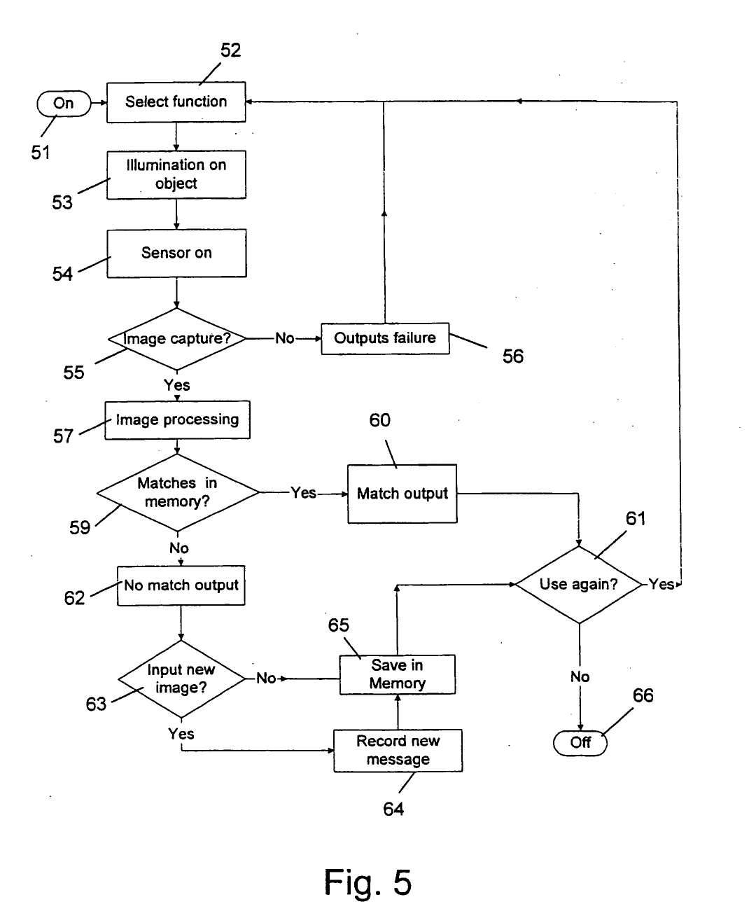

FIG. 5 is a flowchart showing the general operation of the apparatus of the present invention irrespective of the function chosen, according to a preferred embodiment of the present invention. The flowchart starts at block 51 in which the apparatus is turned on. At the next step, block 52, an operation function is selected (e.g., banknote identification, presence of objects and their distance etc). At the next step, block 53, the object to be identified is illuminated by the illumination source 10 (FIG. 2). At the next step, block 54, sensor 22 (FIG. 2) is turned on and senses whether an object is present. At the next step, block 55, the electronic unit 21 (FIG. 2) verifies whether an image has been captured by the camera 15 (FIG. 2). If no image has been captured, then at the next step, block 56, a corresponding failure message is put out, and the operation returns back to block 52, preferably, in order to restart the operation.

If an image has been captured by the camera 15, then, at the next step, block 57, the captured image is processed by the electronic unit 21 while using an appropriate algorithm (e.g., barcode, OCR, pattern recognition and the like). At the next step, block 59, the processed image is matched with corresponding images stored in the memory 42 (FIG. 4). If there is a match between the processed image and a stored image, then, at the next step, block 60, data representing the matched image (i.e., the identified image) is output (e.g., by a display, speaker, etc). At the next step, block 61, the apparatus verifies whether the user wishes to identify another object:
if yes—restarting the operation (block 52);
if no—turning off the apparatus (block 66).

However, if there is no match between the processed image and the image stored in the memory 42, then, at the next step, block 62, a corresponding “no match” output is provided (e.g., via the speaker 16). At the next step, block 63, the apparatus verifies whether the user wishes to input a new image:
If yes—storing the new processed image in memory 42 and recording a new message corresponding to that new image (block 64) and saving the recorded message in memory 42 (block 65). The next step is block 61 as described hereinabove;
If no—then the next step is block 61 as described hereinabove.

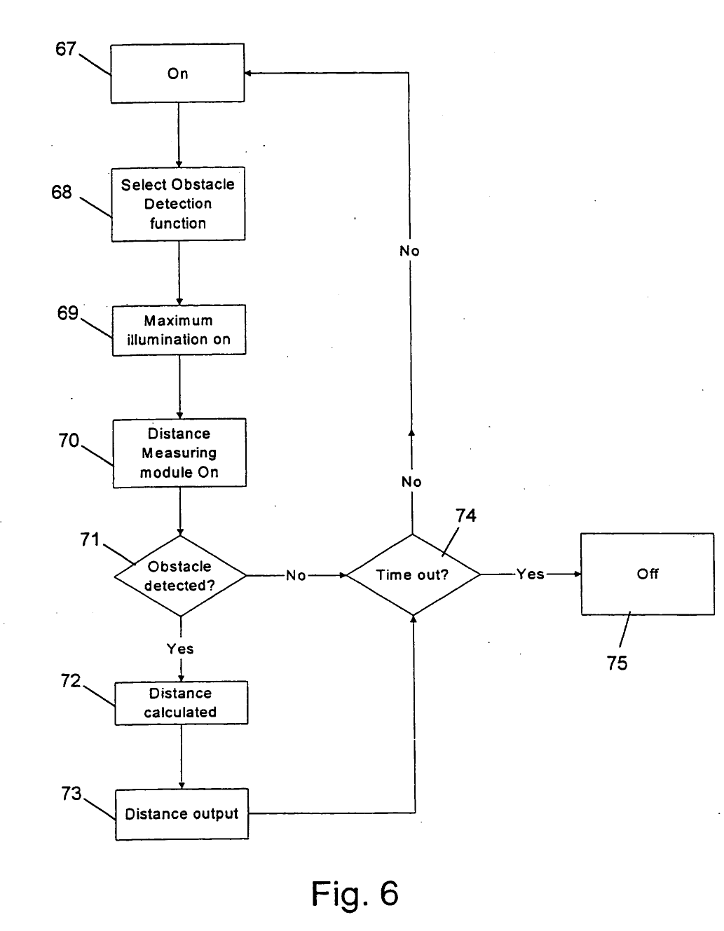

FIG. 6 is a flowchart showing the operation of the apparatus while it is functioning as an Obstacle Detection and Distance Measuring device, according to a preferred embodiment of the present invention. The flowchart starts at block 67 in which the apparatus is turned on. At the next step, block 68, an Obstacle Detection and Distance Measuring operation function is selected. At the next step, block 69, the obstacle to be detected is illuminated by the illumination source 10 (FIG. 2). At the next step, block 70, the distance measuring module is turned on and starts to detect (block 71) whether an obstacle is present. If no obstacle is detected, then, for a predetermined period (block 74), the apparatus tries again to detect the presence of an obstacle (i.e., repeating the steps described in blocks 67-71). After the predetermined period ends (block 74), the apparatus is then turned off (block 75). However, if an obstacle is detected, then at the next step, the distance is calculated (block 72) by the electronic unit 21 (FIG. 2) and the data representing the calculated distance is forwarded to the user (e.g., via a loudspeaker, display or both). At the next step, block 74, if no new obstacle has been detected for the predetermined period, then the apparatus is turned off (block 75).

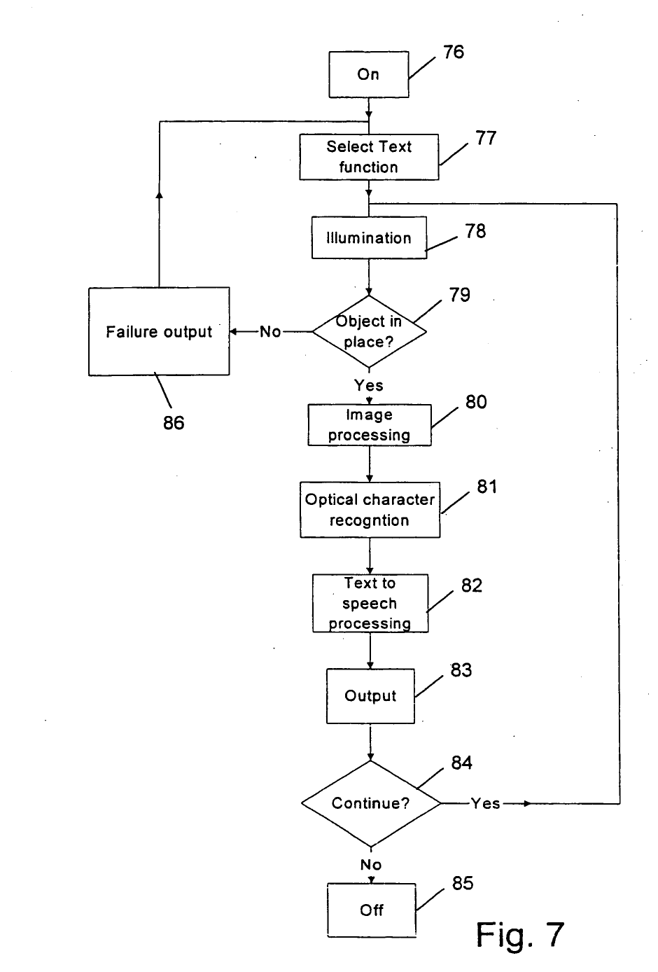

FIG. 7 is a flowchart showing the operation of the apparatus while it is functioning as a Conversion of Text Sentences to Speech device, according to a preferred embodiment of the present invention. The flowchart starts at block 76 in which the apparatus is turned on. At the next step, block 77, a text recognition function is selected. At the next step, block 78, the text to be identified is illuminated by the illumination source 10 (FIG. 2). At the next step, block 79, the apparatus verifies whether there is text to capture (i.e., by camera 15). If no—a failure output is provided (block 86) and the steps described in blocks 77-79 are repeated. If yes—the captured image of the text is processed (block 80) and then an OCR algorithm is executed on the processed image of the text (block 81) and data representing the text is provided. At the next step, block 82, a text to speech algorithm is executed on the text data, and data representing the text is output (block 83) to the user. Preferably, the text to speech algorithm is stored in the memory 42 (FIG. 4). At the next step, block 84, the user may choose whether he wishes to identify further text (i.e., back to block 78) or whether he wishes to end the process (block 85).

FIG. 8 is a flowchart showing the operation of the apparatus while it is functioning as a Color Identification and Image Identification device, which includes banknote and barcode identification, according to a preferred embodiment of the present invention. The flowchart starts at block 87 in which the apparatus is turned on. At the next step, block 88, either the color, barcode or banknote image identification function is selected. At the next step, block 89, the image to be identified is illuminated by the illumination source 10 (FIG. 2). At the next step, block 90, the apparatus verifies whether there is an image to capture (i.e., by the camera 15). If no—a failure output is provided (block 91) and the steps described in blocks 89-90 are repeated. If yes—the captured image is processed (block 92) and then a suitable algorithm (e.g., color analysis, pattern recognition or barcode decoding) is executed on the processed image (block 93) and data representing the captured image is provided. At the next step, block 94, the electronic unit 21 (FIG. 4) compares the data representing the captured image with corresponding data stored in the memory 42 (FIG. 4), and acts as follows:

If there is no match between the data, then a “no match” message is output (block 98). At the next step, block 99, the user may decide whether he wishes to add the data representing the captured image into the memory as a new image, or whether he wishes to make another identification attempt (block 96).

If the user wishes to record a new image, then at the next step, block 100, the user also needs to record a new message representing the new added image, and then save all this information in the memory (block 101). At the next step, block 96, the user may use the apparatus again or turn it off (block 77).

The above examples and descriptions have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1. An apparatus for identifying images, comprising:
a) a body with a wing, said wing being displaceably, preferably pivotally, joined to said body for closing said body, wherein an object bearing an image to be identified may be placed between said body and said wing;
b) a memory for storing recorded data relating to each one of an array of images, said data comprising an array of images and an array of messages corresponding to said array of images;
c) a digital camera located within said body for capturing the image borne by an object placed between said body and said wing but optionally displaceable to capture images of objects placed outside the apparatus;
d) a mirror optionally installed within said body for reflecting said image to be captured by said digital camera;
e) an electronic unit for comparing the data of said captured image with the data of the previously recorded array of images, the data of said captured image being obtained by utilizing optical character recognition algorithm(s) and/or pattern recognition algorithm(s); and
f) a voice module connected to said electronic unit for outputting the message corresponding to said captured image whenever said captured image matches an image of said previously recorded array of images.

2. An apparatus according to claim 1, further comprising a sensor for sensing the existence of an image in the body.

3. An apparatus according to claim 1, in which the electronic unit further comprises a communication port for linking to other devices.

4. An apparatus according to claim 1, in which said apparatus is so shaped that it can receive in a predetermined position the objects bearing images to be identified.

5. An apparatus according to claim 1, in which the electronic unit comprises a central processing unit and the memory.

6. The apparatus according to claim 5, in which the central processing unit uses a vector algorithm for identifying an image which was improperly positioned within said apparatus.

7. The apparatus according to claim 1, in which the messages are audio messages.

8. The apparatus according to claim 7, in which the audio messages are vocal messages.

9. An apparatus according to claim 1, in which the voice module comprises a voice processor, an audio amplifier, a loudspeaker, and a microphone.

10. The apparatus according to claim 1, further comprising a tactile display for outputting a message in a way that can be read by touch.

11. The apparatus according to claim 1, further comprising a visual display for outputting a message in a way that can be read by sight.

12. The apparatus according to claim 3, in which the means for outputting a message is the communication port.

13. The apparatus according to claim 1, further comprising a light source for illuminating the image while the camera captures said image, said light source being located within the body.

14. The apparatus according to claim 13, in which the light source is provided with brightness adjusting means.

15. The apparatus according to claim 1, in which the digital camera is an infra-red camera.

16. The apparatus according to claims 1, in which the light source is an infra-red light source.

17. The apparatus according to claim 1, further comprising means for identifying each separate color in the images or objects and the percentage of each separate color in the images or objects.

18. The apparatus according to claim 17, in which the means for identifying each separate color or colors in the images or objects and the percentage of each separate color in the images or objects, are the digital camera and the electronic unit.

19. The apparatus according to claim 1, further comprising a mechanism for enabling the digital camera to swivel for focusing out of the body, thereby identifying images and/or the color of said images outside the body.

20. The apparatus according to claim 1, in which the messages stored in the memory further include messages, each of which corresponds to a specific color.

21. The apparatus according to claim 20, in which the corresponding message is produced audibly by the voice module.

22. The apparatus according to claim 20, in which the corresponding message is displayed on the tactile display.

23. The apparatus according to claim 20, in which the corresponding message is displayed on the visual display.

24. The apparatus according to claim 20, in which the corresponding message is output via the communication port.

25. The apparatus according to claim 1, in which the electronic unit further comprises means for identifying images that were washed out or faded.

26. The apparatus according to claim 25, in which the means for identifying washed out or faded images are image processing algorithms.

27. The apparatus according to claim 1, further comprising means for inputting new images into the array of images stored in the memory.

28. The apparatus according to claim 27, in which the means for inputting new images are the digital camera and the electronic unit.

29. The apparatus according to claim 1, further comprising a microphone for recording new messages.

30. The apparatus according to claims 1, further comprising means for inputting new messages into the array of messages stored in the memory, said new messages corresponding to images that have been input into the array of images stored in the memory.

31. The apparatus according to claim 30, in which the means for inputting new messages are the microphone and the electronic unit.

32. The apparatus according to claim 1, in which the electronic unit further comprises means for identifying images that are barcodes.

33. The apparatus according to claim 32, in which the means for identifying barcode images are barcode algorithms.

34. The apparatus according to claim 1, in which the electronic unit further comprises means for identifying images that are a printed string of alphanumeric signs, and outputting them audibly as speech.

35. The apparatus according to claim 34, in which the means for identifying printed sentence images and outputting them audibly as speech are optical character recognition software processed by the central processing unit, and the voice module.

36. The apparatus according to claim 1, further comprising means for magnifying images and objects, and means for outputting data representing the magnification.

37. The apparatus according to claim 36, in which the means for magnifying images and objects are the camera, the electronic unit, and a magnification algorithm.

38. The apparatus according to claims 11, in which the means for outputting the magnification data is the visual display.

39. The apparatus according to claims 3, in which the means for outputting the magnification data is the communication port.

40. The apparatus according to claim 1, further comprising means for detecting the presence of objects within a fixed region, and means for outputting the detection of said objects.

41. The apparatus according to claim 40, in which the means for detecting the presence of objects are the camera and the electronic unit.

42. The apparatus according to claim 40, in which the means for outputting the detection of objects is the voice module.

43. The apparatus according to claim 40, in which the means for outputting the detection of objects is the tactile display.

44. The apparatus according to claim 40, in which the means for outputting the detection of objects is the visual display.

45. The apparatus according to claim 40, in which the means for outputting the detection and the distance of objects is the communication port.

46. An apparatus for identifying images, substantially as described and illustrated.
